(19) United States
(12) Patent Application Publication
(10) Pub. No.: US 2003/0043795 A1
(43) Pub. Date: Mar. 6, 2003

(54) System and method for arranging a connection between the logical sides of the net-work element of a telecommunication network

(76) Inventors: Timo Ylonen, Espoo (FI); Rego Koivula, Espoo (FI)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/180,125

(22) Filed: Jun. 27, 2002

Related U.S. Application Data
(63) Continuation of application No. PCT/FI00/00983, filed on Nov. 10, 2000.

(30) Foreign Application Priority Data
Dec. 28, 1999 (FI) 19992795

(51) Int. Cl. H04L 12/50

(52) U.S. Cl. 370/386

(57) ABSTRACT

The present invention relates to a method and system for arranging a connection between the logical sides of a network element of a telecommunication network, which system comprises a network element (210) which comprises units that have been logically divided into a first side and second side and which units comprise the multiplexing unit of the first side (211_{A2}), and which units comprise the multiplexing unit of the second side (211_{R2}) and which network element (210) has been at least partly implemented by means of the ATM technique. In accordance with the invention, the system further comprises an ATM interface (212) for connecting the multiplexing unit of the first side (211_{A2}) and the multiplexing unit of the second side (211_{R2}) to one another. The present invention provides the advantage that it makes it possible to arrange a connection between the logically divided sides of a network element of a telecommunication network, in which case the sides in question see the resources of one another.

### FIELD OF THE INVENTION

The invention relates to telecommunication. In particular, the invention relates to a new and advanced method and system for arranging a connection between the logical sides of a network element of a telecommunication network.

### PRIOR ART

A telecommunication network such as a telephone network typically comprises one or more network elements. A network element is herein used to mean a telecommunications system or a group of systems or a part of a system as well as its peripheral equipment; or some other unit in a telecommunication environment that may be managed, monitored or controlled in the network and that has at least one standard interface. A typical example of a network element is a digital telephone exchange. The network element typically comprises a set of units that implement different functions of the element. Examples of these units are, e.g. computer units that are responsible, e.g. for the control of the functions of the network element; multiplexing units that are responsible, e.g. for the multiplexing functions of the network element; and switching field units that are responsible for the switching functions of the network element.

Usually in practise each unit has been implemented as a doubled pair of units. In that case in a normal state of a network element, e.g. the first unit of a pair of multiplexing units is active carrying out the multiplexing functions of the network element, and the second, the redundant unit is in reserve, e.g. for failure cases.

Instead when, e.g. introducing and/or testing a new software version the units of the network element are logically divided into a first side and a second side. In that case, typically the first unit of each pair of units is divided onto the first side, and the second unit onto the second side. The units of the first side are used, e.g. for the normal functions of the relevant network element such as, e.g. traffic transmission, and at the same time the units of the second side may be used for testing, e.g. a new software version to be introduced.

The consequence of the aforementioned logical division is that the transmission of messages between the first and the second unit is not possible. While the network being in a divided state the units are able to transmit traffic solely via one multiplexer. However, the multiplexer concerned is not capable of sending messages into both switching field units because also the switching field units in question are divided. In other words, both of the switching field units are active and see the different multiplexers of the pair of multiplexers as active, in which case the boundary line between the logic sides cannot be crossed.

The following section includes a brief description of the features of the ATM technique that in some way or another touch upon the invention.

ATM (Asynchronous Transfer Mode, ATM) is a connection-oriented packet-switched data-transfer method which is characterised in a data transfer using cells of standard size. The cells consist of a five bit long title and a 48 bit long information part. The title fields comprise a virtual path identifier VPI and virtual channel identifier VCI, a payload type identifier PTI, cell loss priority, CLP, and header error control, HEC that makes it possible to correct errors of one bit and detect errors of two bits. In the ATM switch, the cells are transferred from the logical input channel into one or more logical output channels. The logical channel consists of the number of a physical link, such as an optical fibre, and the channel identifier on this link, i.e. the VPI/VCI information. One physical medium of transmission, such as an optical fibre, may include several virtual paths VP and each virtual path may include several virtual channels VC.

Since the cells are of standard size, the switching in the ATM switches may be carried out based on the cell header at device level and therefore extremely fast. The cells belonging to different connections are distinguished from each other with the aid of the virtual path and virtual channel identifiers. When establishing the connection, a fixed route is defined through the network, i.e. a virtual connection along which the cells of the connection are routed. In the network nodes, the cells are switched based on the VPI/VCI values. The VPI/VCI values of the cells are connection-slot-oriented and therefore tend to change in conjunction with the switching of a VP or VC level. In the end of the transmission the connection is set down.

An ATM protocol is usually described by referring to an ATM protocol model, which is a layer model resembling the OSI model (Open Standards Interconnection, OSI). Uppermost in the model there is the data coming from the user. Below it there is an ATM adaptation layer AAL. Below it there is an ATM layer beneath which there is a physical layer PHY). In addition, the AAL layer is divided into two parts—the SAR layer (Segmentation And Reassembly, SAR) and the CS layer (Convergence Sublayer, CS). Further, the CS layer is divided into two sub-layers, which are the SSCS layer (Service Specific Convergence Sublayer, SSCS) and the CPCS layer (Common Part Convergence Sublayer, CPCS).

The ATM adaptation layer slices the frames of the upper layers, places the pieces in the cells and puts the frames together at the opposite end.

The ATM layer for its part offers the cell transfer service to the AAL layer. It handles solely the cell header being responsible for the cell switching, multiplexing, demultiplexing, the generation and deletion of the cell header as well as generic flow control, GFC) in the user network interface UNI. In addition, the detection and correction of the header errors as well as block synchronization are part of the responsibilities of the ATM layer.

Also the physical layer is divided into two sub-layers, the PMD sublayer (Physical Medium Dependent, PMD) which is responsible for the transmission-specific tasks at bit level; and the transmission convergence layer TCS which is responsible for the adaptation of the cells to each transmission protocol as well as cell restriction, error checking of the cell header, and balancing the cell rate.

The interface between the integrated circuits and the ATM layer implementing the functions of a physical layer is standardized by the ATM forum having the names UTOPIA, An ATM-PHY Interface Specification, Level 1 and UTOPIA, An ATM-PHY Interface Specification, Level 2, which are hereinafter referred to as UTOPIA Level 1 and UTOPIA Level 2. In practice, a device based on the ATM technique has to be implemented using the ATM micro circuits commercially available that are implementing the interface consistent with the UTOPIA specifications. The interface has become a de facto manufacturing standard which is followed by the component suppliers manufacturing the integrated ATM circuits.

In the UTOPIA interface the data has been defined as 8 or 16 bit long depending on the implemented bit rate (UTOPIA Level 1 and Level 2) In the interface, nothing but the ATM cell data is transferred, and it includes the control, i.e. so-called handshaking signals needed in a two-way transfer. The circuit manufacturers implement their circuits implementing the functions of an ATM layer as hosts, because the UTOPIA specification defines the circuits of an ATM layer as hosts and because the manufactures are not expected to know in what kind of environment their clients use their circuits. The circuits of a physical layer are correspondingly slaves. The slaves connected to a UTOPIA bus may communicate solely with the host device but not with each other.

### OBJECTIVE OF THE INVENTION

The objective of the present invention is to disclose a new kind of method and system that eliminates the above disadvantages or at least significantly alleviates them. One specific objective of the invention is to disclose a method and system that enable the arranging of a connection between the sides of a logically divided network element of a telecommunication network.

### SUMMARY OF THE INVENTION

In the present invention, a connection is arranged between the logical sides of a network element of a telecommunication network, such as, e.g. a telephone network (e.g. Public Switched Telephone Network, PSTN; Public Land Mobile Network, PLMN; Integrated Services Digital Network, ISDN), or the logical sides of a network element of a telecommunication network utilizing the IP protocol (Internet Protocol). The network element in question comprises units. A unit is herein used to mean a functional configuration, in other words, e.g. the aforementioned units are necessarily not implemented as units being physically separated from each other, instead they may implemented also as an integral configuration. Further, different network elements may comprise different combinations of different units. Furthermore, the network element may comprise only one of a certain unit, in which case the unit in question is active, or the network element may comprise several pieces of a certain unit, in which case typically one of the units is active while the rest of them are redundant, i.e. doubled. Typically in a normal state of a network element the active units are responsible for the function of the element in question, and the redundant units are in reserve, e.g. for failure cases.

The units of the network element in question are logically divided into a first side and second side. Logical division means division into two sides logically separated from each other, which may be implemented, e.g. in such a way that the units of one side are eliminated from the computer addressing tables of the logical addressing. In other words, the division may be made using an address modification. Furthermore, the division may be implemented by inhibiting the physical connection between some units, i.e. data arriving from a certain unit is not accepted. The consequence of such a division is that no logical level computer addressing is used between the units of the first side and second side. In other words, a message cannot be sent from the first side to the second side using a logical address and vice versa, because the units of the sides in question are invisible to each other as concerns logical addresses.

It is to be noted that the logical division may be made either at network element level, in which case the network element is logically divided into first side and second side, or the logical division may be made at unit level, in which case one or more units are divided into a first side and second side Thereby the term “unit of a first side” refers both to a whole unit that, according to the logical division made at network element level, is arranged to belong to the first side, and a first side of such a whole unit which unit, according to the logical division made at unit level, is divided into a first side and second side. Correspondingly, the term “unit of a second side” refers both to a whole unit that, according to the logical division made at network element level, is arranged to belong to the second side, and a second side of such a whole unit which unit, according to the logical division made at unit level, is divided into a first side and second side.

Further the units in question comprise the multiplexing unit of the first side as well as the multiplexing unit of the second side which are responsible, e.g. for the multiplexing functions of the network element. Further, the network element in question has been implemented at least partly by utilizing the ATM technique.

In accordance with the invention, the multiplexing unit of the first side and the multiplexing unit of the second side are connected to one another by means of an ATM interface. An ATM interface is used to mean an interface that has been implemented by utilizing the ATM technique.

In an embodiment of the invention, the multiplexing unit of the first side comprises the first UTOPIA adaptation interface by means of which an interface consistent with the UTOPIA Level 2 specifications is arranged. Further the multiplexing unit of the second side comprises the second UTOPIA adaptation interface by means of which an interface consistent with the UTOPIA Level 2 specifications is arranged.

In an embodiment of the invention, the first UTOPIA adaptation interface comprises a set of interface parameters, the second UTOPIA adaptation interface comprises another set of interface parameters, and the first set of interface parameters and the second set of interface parameters concerned are of the same content.

In an embodiment of the invention, the network element further comprises a computer unit of the first side, a switching field unit of the first side, computer unit of the second side and switching field unit of the second side. The computer units are responsible, e.g. for the control of the functions of the network element. The switching field units are responsible, e.g. for the switching functions of the network element.

In an embodiment of the invention, the network element is a digital telephone exchange.

As compared with prior art the present invention provides the advantage that it makes it possible to arrange a connection between the sides of a logically divided network element, in which case the sides in question see the resources of one another. This on the other hand enables a physical message communication, i.e. it is possible to send messages from each of the logic sides to the opposite side. In addition, the application programs are capable of discussing with one another, if required.

### LIST OF ILLUSTRATIONS

In the following section, the invention will be described by way of examples of its embodiments with reference to the attached drawing, in which

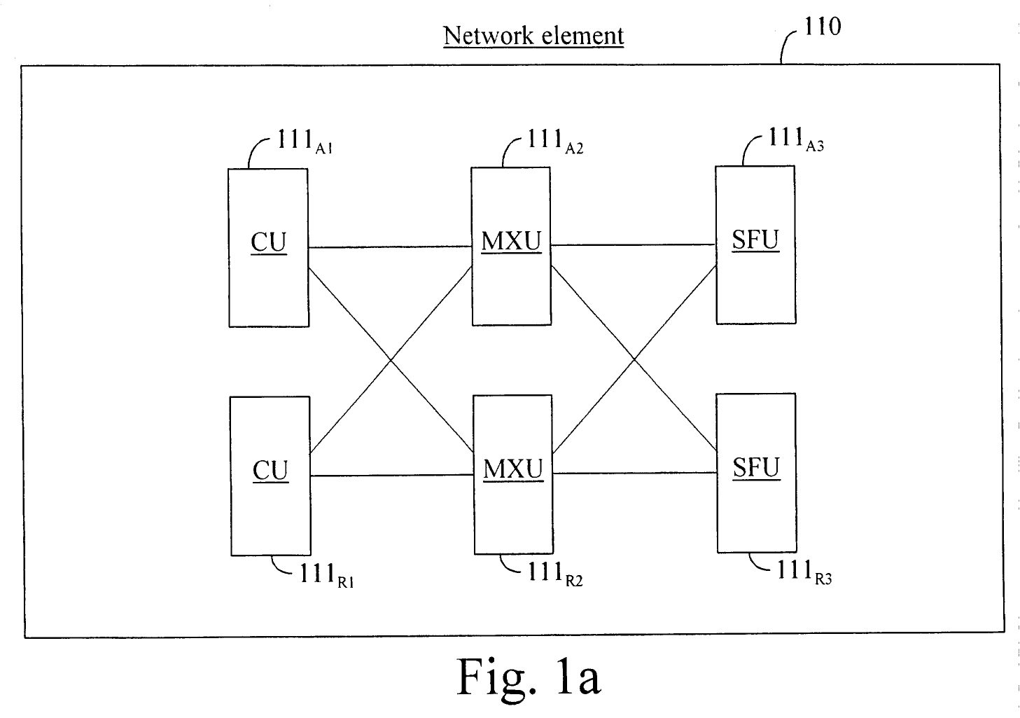

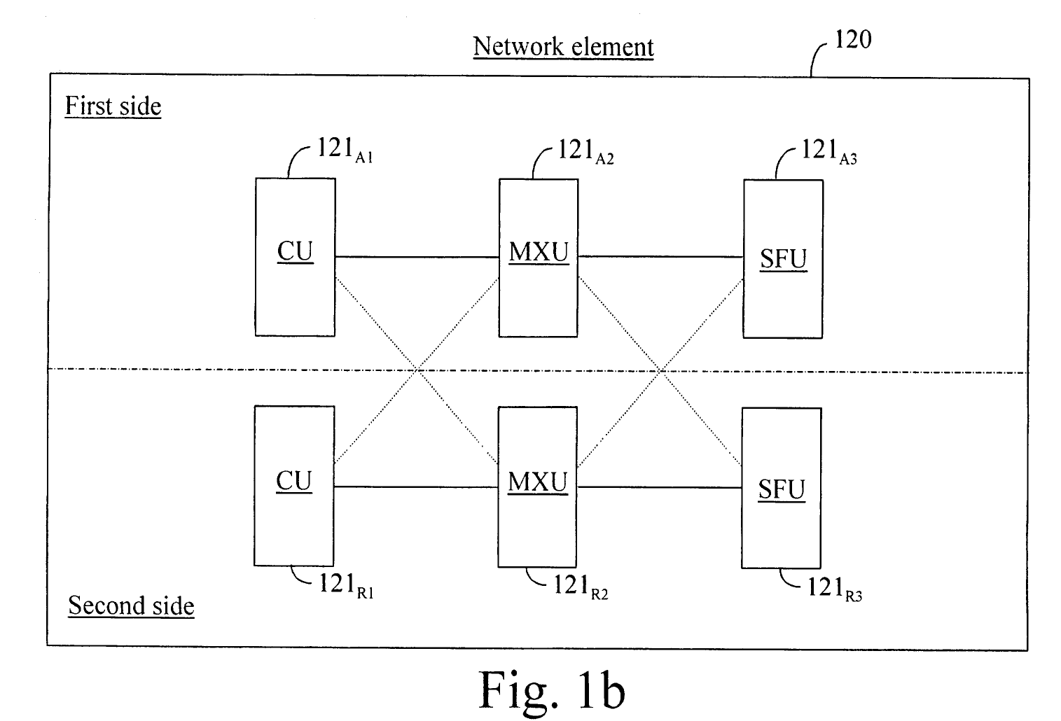

FIG. 1a is a schematic representation of a prior-art system.

FIG. 1b is a schematic representation of a prior-art system;

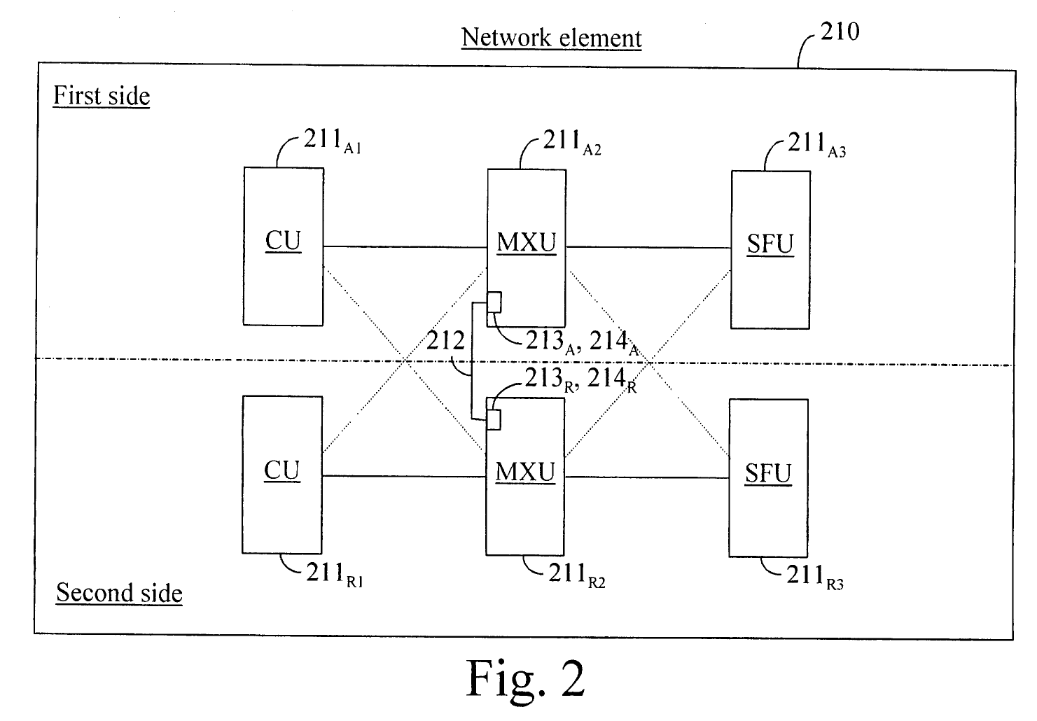

FIG. 2 is a schematic representation of a system of the present invention; and

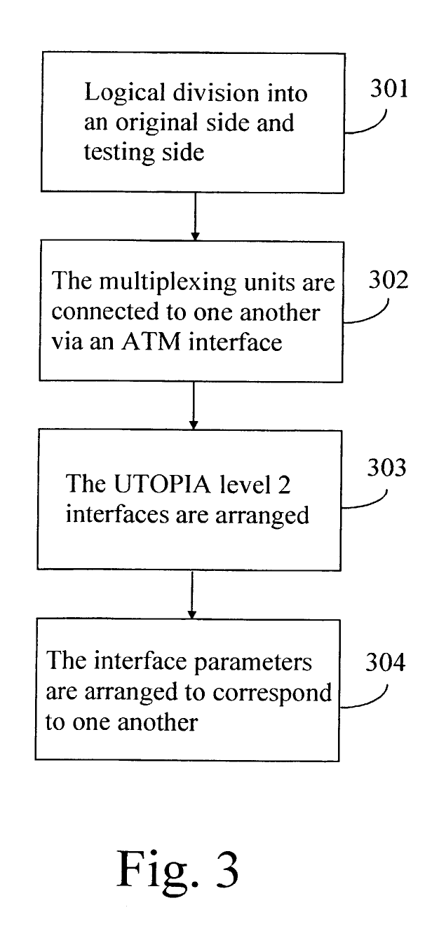

FIG. 3 is a schematic representation of a system of the present invention.

### DETAILED DESCRIPTION OF THE INVENTION

FIG. 1a is a block diagram illustrating, by way of example, the components of one prior-art system. To be precise, FIG. 1a describes the network element 110 in a normal operating state. In the exemplary case as illustrated in FIG. 1a, the system comprises a network element 110 comprising units. The network element 110 is, e.g. a digital telephone exchange. In the exemplary case as illustrated in FIG. 1a, the units are an active computer unit 111_{A1} and redundant computer unit 111_{R1}, active multiplexing unit 111_{A2} and redundant multiplexing unit 111_{R2} as well as an active switching field unit 111_{A3} and redundant switching field unit 111_{R3}. It is to be noted that the configuration as shown by FIG. 1a is a simplified example to help to clarify the matter. In practice, there are more computer units than illustrated in FIG. 1a. The active units are used, e.g. to carry out the traffic transmitting tasks of the network element concerned, and generally also other functions related to normal operation of the aforementioned network element, such as, e.g. billing, compiling statistics, adding/deletion of subscribers and/or updating the visitor location register. The redundant units are in reserve, e.g. for failure cases.

As illustrated in FIG. 1a, in a normal state of the network element 110, each computer unit 111_{A1}, 111_{R1} has a connection with each multiplexing unit 111_{A2}, 111_{R2} and vice versa. Correspondingly, each multiplexing unit 111_{A2}, 111_{R2} has a connection with each switching field unit 111_{A3}, 111_{R3} and vice versa. However, messages are sent from the active computer unit 111_{A1} and the redundant computer unit 111_{R1} solely to the active multiplexing unit 111_{A2}. From the active multiplexing unit 111_{A2} and redundant multiplexing unit 111_{R2} messages are sent both to the active switching field unit 111_{A3} and redundant switching field unit 111_{R3}. Instead, the active multiplexing unit 111_{A2} and redundant multiplexing unit 111_{R2} accept messages solely from the active switching field unit 111_{A3}. The active switching field unit 111_{A3} and redundant switching field unit 111_{R3} accept messages solely from the active multiplexer 111_{A2}. The active switching field unit 111_{A3} and redundant switching field unit 111_{R3} send messages both to the active multiplexing unit 111_{A2} and redundant multiplexing unit 111_{R2}.

FIG. 1b is a block diagram illustrating, by way of example, the components of one prior-art system. To be precise, FIG. 1b describes a prior-art network element 120 which has been logically divided into a first side and second side. In the exemplary case as illustrated in FIG. 1b, the system comprises a network element 120 comprising units. The network element 120 is, e.g. a digital telephone exchange. In the exemplary case as illustrated in FIG. 1b, the units are computer unit 121_{A1}, multiplexing unit 121_{A2}, switching field unit 121_{A3} arranged on the first side as well as computer unit 121_{R1}, multiplexing unit 121_{R2}, and switching field unit 121_{R3} arranged on the second side. It is to be noted that the configuration as shown by FIG. 1b is a simplified example to help to clarify the matter. In practice, there are generally more computer units than illustrated in FIG. 1b. The units of the first side are used, e.g. to carry out the traffic transmitting tasks of the network element concerned, and generally also other functions related to normal operation of the aforementioned network element, such as, e.g. billing, compiling statistics, adding/deletion of subscribers and/or updating the visitor location register. The units of the second side are meant, e.g. for testing a new piece of software to be introduced. It is worth noting that although it is assumed in FIG. 1b that the logical division would have been made at network element level, the division may, nevertheless, be made at unit level. This happens, e.g. by dividing each unit internally into a first side and second side. Still also in that case, the actions to be taken are effected analogously to the division made at element level.

In the exemplary case as illustrated in FIG. 1b all units are active. As in the case of FIG. 1a, also in the case of FIG. 1b, the multiplexing units accept messages solely from the active switching field units, and correspondingly, the switching field units accept messages solely from the active multiplexing units. However, the consequence of the logical division is that each unit sees only the units on its logical side as active. This has been illustrated in FIG. 1b by describing the connections between the logical sides by means of a broken line. In other words, e.g. the switching field unit of the first side 121_{A3} sees the multiplexing unit of the second side 121_{R2} as passive, and is therefore not accepting messages coming from it. The consequence is for instance the fact that in the prior-art solutions, no messages may be transmitted between the computer units 121_{A1} and 121_{R1} while the network element being logically divided into a first and second side.

FIG. 2 is a block diagram illustrating, by way of example, the components of one system of the invention. To be more precise, FIG. 2 describes a network element 210 in accordance with the invention which has been logically divided into a first side and second side. In the exemplary case as illustrated in FIG. 2, the system comprises the network element 210 which comprises units. The network element 210 is, e.g. a telephone exchange. In the exemplary case as illustrated in FIG. 2, the units are computer unit 211_{A1}, multiplexing unit 211_{A2}, switching field unit 211_{A3} arranged on the first side as well as a computer unit 211_{R1}, multiplexing unit 211_{R2}, and switching field unit 211_{R3} arranged on the second side. It is worth noting that the configuration as shown by FIG. 2 is a simplified example to help to clarify the matter. In practice, there are usually more computer units than illustrated in FIG. 2. The units of the first side are used, e.g. to carry out the traffic transmitting tasks of the network element concerned, and generally also other functions related to normal operation of the aforementioned network element, such as, e.g. billing, compiling statistics, adding/deletion of subscribers and/or updating the visitor location register. The units of the second side are meant, e.g. for testing a new piece of software to be introduced. It is worth noting that although it is assumed in FIG. 1b that the logical division would have been made at network element level, the division may, nevertheless, be made at unit level. This happens, e.g. by dividing each unit internally into a first side and second side. Still also in that case, the actions to be taken are effected analogously to the division made at element level.

In the exemplary case as illustrated in FIG. 2 all units are active. As in the cases of FIG. 1a and 1b also in the case of FIG. 2, the multiplexing units accept messages solely from the active switching field units, and correspondingly, the switching field units accept messages solely from the active multiplexing units. However, the consequence of the logical division is that each unit sees only the units on its logical side as active. This has been illustrated in FIG. 2 by describing the connections between the logical sides by means of a broken line. In other words, e.g. the switching field unit of the first side 211_{A3} sees the multiplexing unit of the second side 211_{R2} as passive, and is therefore not accepting messages coming from it.

In accordance with the invention in FIG. 2, the multiplexing unit of the first side 211_{A2} and the multiplexing unit of the second side 211_{R2} have been connected to one another by means of an ATM interface 212. The ATM interface 212 is in practise, e.g. a cabling between the multiplexers 211_{A2} and 211_{R2} that meets the requirements consistent with the ATM interface. Further in accordance with the invention, the multiplexing unit of the first side 211_{A2} comprises the first UTOPIA adaptation interface 213_{A} by means of which the ATM interface consistent with the UTOPIA Level 2 specifications is arranged. Further the multiplexing unit of the second side 211_{R2} comprises a second UTOPIA adaptation interface 213_{R} by means of which an ATM interface consistent with the UTOPIA Level 2 specifications is arranged. The first UTOPIA adaptation interface 213_{A} comprises a first set of ATM interface parameters 214_{A}, the second UTOPIA adaptation interface 213_{R} comprises a second set of ATM interface parameters 214_{R}, and the first set of interface parameters 214_{A} and second set of interface parameters 214_{R} are identical in content. The ATM interface 212 shows to the units of the first side as a connection to the external logical interface. Correspondingly, the ATM interface shows to the units of the second side as a connection to the external logical interface. Thanks to the invention, messages may be transmitted, e.g. between the computer units 211_{A1} and 211_{R1} even in a case when the network element 210 has been logically divided into a first side and second side, which on the other hand enables, e.g. the fact that programs of an application level are capable of discussing with one another, if required.

FIG. 3 is a block diagram illustrating, by way of example, one method of the invention by means of which method a connection is arranged between the logical sides of the network element of a telecommunication network. At a step 301, the units of the network element are logically divided into a first side and second side. The units of the first side are used, e.g. to carry out the traffic transmitting tasks of the network element concerned, and generally also other functions related to normal operation of the aforementioned network element, such as, e.g. billing, compiling statistics, adding/deletion of subscribers and/or updating the visitor location register. The units of the second side are meant, e.g. for testing a new piece of software to be introduced. The network element has been at least partly implemented by means of the ATM technique. The logical division is effected in such a way that both the first side and the second side comprise a multiplexing unit. At a step 302, the multiplexing units in question are connected with one another by means of an ATM interface, which is, e.g. a cabling between the multiplexers in question that meets the requirements consistent with the ATM interface. At a step 303, in both multiplexing units, an ATM interface consistent with the UTOPIA Level 2 specifications is arranged using the UTOPIA adaptation interfaces. At a step 304, the interface parameters of the first and second UTOPIA adaptation interfaces in question are arranged to correspond to one another in content.

The invention is not restricted to the examples of its embodiments presented above, instead many variations are possible within the scope of the inventive idea defined by the claims.

1. A system for arranging a connection between the logical sides of a network element of a telecommunication network, which system comprises:
a network element (210) which comprises units that are logically divided into a first side and second side and which units comprise the multiplexing unit of the first side (211_{A2}) and which units comprise the multiplexing unit of the second side (211_{R2}) and which network element (210) has been at least partly implemented by means of the ATM technique,
characterised in that the system further comprises:
an ATM interface (212) for connecting the multiplexing unit of the first side (211_{A2}) and the multiplexing unit of the second side (211_{R2}) to one another.

2. A system as defined in claim 1, characterised in that
the multiplexing unit of the first side (211_{A2}) comprises a first UTOPIA adaptation interface (213_{A}) for arranging a UTOPIA Level 2 interface, and
the multiplexing unit of the second multiplexing unit (211_{R2}) comprises a second UTOPIA adaptation interface (213_{R}) for arranging a UTOPIA Level 2 interface.

3. A system as defined in claim 2, characterised in that
the first UTOPIA adaptation interface (213_{A}) comprises a first set of interface parameters (214_{A}),
the second UTOPIA adaptation interface (213_{R}) comprises a second set of interface parameters(214_{R}), and
the first set of interface parameters (214_{A}) and the second set of interface parameters (214_{R}) are identical in content.

4. A system as defined in claim 1, 2, or 3, characterised in that the network element (210) further comprises:
a computer unit of the first side (211_{A1}) as well as a switching field unit of the first side (211_{A3}) , and
a computer unit of the second side (211_{R1}) as well as a switching field unit of the second side (211_{R3}).

5. A system as defined in claim 1, 2, 3, or 4, characterised in that the network element (210) is a digital telephone exchange.

6. A method for arranging a connection between the logical sides of the network element of a telecommunication network which method comprises the step of:
dividing the units of the network element at least partly implemented by means of the ATM technique logically into a first side and second side in such a way that each side comprises a multiplexing unit,
characterised in that the method further comprises the step of:
combining the multiplexing unit of the first side and the multiplexing unit of the second side to one another by means of an ATM interface.

7. A method as defined in claim 6, characterised in that the method further comprises the step of:
arranging a UTOPIA Level 2 interface for the multiplexing unit of the first side using the first UTOPIA adaptation interface.
arranging a UTOPIA Level 2 interface for the multiplexing unit of the second side using the second UTOPIA adaptation interface.

8. A method as defined in claim 7, characterised in that the method further comprises the step of:
arranging the interface parameters of the first and second UTOPIA adaptation interfaces concerned to correspond to one another in content.
